(19) United States
(12) Patent Application Publication
(10) Pub. No.: US 2005/0060206 A1
(43) Pub. Date: Mar. 17, 2005

(54) Mobilization income protection plan

(76) Inventor: Ralph Mitchell, Braintree, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/820,198

(22) Filed: Apr. 6, 2004

Related U.S. Application Data
(60) Provisional application No. 60/502,350, filed on Sep. 12, 2003.

(51) Int. Cl. G06F 17/60

(52) U.S. Cl. 705/4

(57) ABSTRACT

A method of insuring military reserve component personnel for reduction of income due to active military duty includes collecting payments on behalf of a reservist, amounts of the payments being based upon civilian income of the reservist and desired compensatory income during times of active military duty, and providing the desired compensatory income for the reservist during at least a portion of a first time period of active military duty of the reservist in response to receiving a request for compensatory income on behalf of the reservist.

### CROSS-REFERENCE TO RELATED ACTIONS

This application claims the benefit of U.S. Provisional Application No. 60/502,350 filed Sep. 12, 2003.

### FIELD OF THE INVENTION

The invention relates to insurance policies, especially for military personnel.

### BACKGROUND OF THE INVENTION

Military reservists come from many walks of civilian life, with a correspondingly wide range of civilian salaries and responsibilities. Military reservists include reserve component personnel for the various military branches of the Government, including the Army, the Navy, the Marines, the Air Force, the Coast Guard, the National Guard, etc. Military reservists may be called to active duty at a moments notice to serve their country, but this service carries with it potential financial detriment to the reservists. Primary reasons for negative financial impact on reservists for being called to active duty are the difference between a reservist's civilian and military salary, costs associated with replacing a reservist who is a key person in a business such as a small business, and lack of employment upon return or shortly after return from active duty.

Quite possibly the biggest financial issue facing a military reservist is the gap between the reservist's civilian pay and military pay. The civilian salary of reservists often exceeds the military pay of the reservist. This is especially prevalent among seasoned professionals such as civilian doctors, attorneys, corporate executives, and business owners. This gap in pay can quickly lead to financial hardship on a reservist's family. While a reservist's pay may decrease when called to active duty, the reservist's debt volume, particularly for long-term debt such as car loans and mortgages, may remain relatively steady. The Soldier's and Sailor's Relief Act of 1940 has provisions to force creditors to accept a reduced interest rate on debts owed by reservists should involuntary mobilization occur, but these reductions often do little to lower the overall payments that creditors still demand.

Further, for a reservist that own or run small businesses, or is otherwise a “key person” in a business, an issue arises as to who will be entrusted to perform the reservist's duties until the reservist returns from duty. If a suitable, qualified replacement can be found, this substitute will need to be paid.

Further still, when reservists return from a deployment, the reservists may not return to find their jobs waiting, or may find that their jobs soon vanish. Some employers may not take returning reservists back, some may have laid off part of their workforce including the reservist(s), while others may have failed altogether leaving no jobs. Also, reservists may have been replaced and offered other jobs with the employer that are less desirable than those previously held. Reservists may also return to jobs that have been slated to be eliminated, thus leaving the reservists jobless shortly after their return. Reservists may also find themselves without jobs upon, or shortly after, their return for any number of other reasons.

To help provide for supplemental income for reservists called to active duty, the Government did attempt to implement an insurance plan for reservists. This plan, however, was financially unsound and failed in short order, requiring termination of the plan and a financial bailout signed by the President.

### SUMMARY OF THE INVENTION

In general, in an aspect, the invention provides a method of insuring military reserve component personnel for reduction of income due to active military duty, the method including collecting payments on behalf of a reservist, amounts of the payments being based upon civilian income of the reservist and desired compensatory income during times of active military duty, and providing the desired compensatory income for the reservist during at least a portion of a first time period of active military duty of the reservist in response to receiving a request for compensatory income on behalf of the reservist.

Implementations of the invention may include one or more of the following features. The payment amounts are further based on at least one personal factor associated with the reservist. The the at least one personal factor is at least one of an age of the reservist, length of occupation of the reservist in the reservist's current civilian occupation, length of occupation of the reservist in the reservist's current military occupation, formal academic background of the reservist, marital status of the reservist, number of household dependents of the reservist, military pay grade of the reservist, number of years of military experience, number of years of civilian employment, level of military responsibility, whether and how many troops the reservist commands at the reservist's military occupation, and level of civilian-employment responsibility. Providing the compensatory income is inhibited until at least one of a first threshold cumulative total of payments is collected, a second threshold of number of payments is collected, and a third threshold of a designated time period during which payments have been collected elapses. The at least a portion of the compensatory income is provided during a second time period after the first time period, wherein the reservist is off active military duty during the second time period. The compensatory income includes a desired replacement income for paying a person to replace the reservist at the reservist's civilian occupation while the reservist is on active military duty, and wherein the payment amounts further depend upon the desired replacement income.

In general, in another aspect, the invention provides an insurance policy for military reserve component personnel for compensating for reduction of income due to active military duty, the insurance policy including provisions for collecting payments, amounts of the payments being based upon civilian income of a reservist and desired compensatory income for the reservist during at least times of active military duty of the reservist, receiving a request for compensatory income, and providing the desired compensatory income during at least a portion of a time period of active military duty of the reservist.

Implementations of the invention may include one or more of the following features. The payment amounts are further based on at least one personal factor associated with the reservist. The at least one personal factor is at least one of an age of the reservist, length of occupation of the reservist in the reservist's current civilian occupation, length of occupation of the reservist in the reservist's current military occupation, formal academic background of the reservist, marital status of the reservist, number of household dependents of the reservist, military pay grade of the reservist, number of years of military experience, number of years of civilian employment, level of military responsibility, and level of civilian-employment responsibility. The policy further includes a provision to inhibit the compensatory income from being provided until at least one of a first threshold cumulative total of payments is collected, a second threshold of number of payments is collected, and a third threshold of a designated time period during which payments have been collected elapses. The provision to inhibit the compensatory income from being paid allows a portion, less than a full amount, of the compensatory income to be paid before at least one of the first threshold cumulative total of payments is collected, the second threshold of number of payments is collected, and the third threshold of the designated time period during which payments have been collected elapses. The policy further includes a return of premium provision for returning a portion of the payments collected if at least one return condition is satisfied, the payment amounts further depending upon election of a return of premium option. The return condition is at least one of that no requests for compensatory income are received, and that compensatory income provided under the plan is below a threshold level relative to a sum of payments collected under the insurance plan.

In general, in another aspect, the invention provides an insurance policy for military reserve component personnel for compensating for reduction of income due to active military duty, the insurance policy including provisions for collecting payments, amounts of the payments being based upon desired compensatory income for a reservist during at least times of active military duty of the reservist, providing the desired compensatory income during at least a portion of a first time period of active military duty of the reservist, and providing at least a portion of the compensatory income during a second time period after the first time period, wherein the reservist is off active military duty during the second time period.

Implementations of the invention may have amounts of the payments being also based upon civilian income of the reservist.

In general, in another aspect, the invention provides an insurance policy for military reserve component personnel for compensating for reduction of income due to active military duty, the insurance policy including provisions for collecting payments, amounts of the payments being based upon desired compensatory income for a reservist during at least times of active military duty of the reservist, and providing the desired compensatory income during at least a portion of a time period of active military duty of the reservist, where the compensatory income includes a desired replacement income for paying a person to replace the reservist while the reservist is on active military duty, and where the payment amounts depend upon the desired replacement income.

Implementations of the invention may have amounts of the payments being also based upon civilian income of the reservist.

In general, in another aspect, the invention provides an insurance policy for military reserve component personnel for compensating for business impact of the personnel's absence due to active military duty, the insurance policy including provisions for collecting payments, amounts of the payments being based upon desired compensatory income that is based on expected financial impact on a business of a reservist's absence during at least times of active military duty of the reservist, and providing the desired compensatory income during at least a portion of a time period of active military duty of the reservist.

Implementations of the invention may include one or more of the following features. The amounts of payments are based on at least one of number of reservists in the business and likelihood of the reservist(s) being mobilized. The desired compensation is at least partially dependent on at least one of a number of persons mobilized, length of expected mobilization(s), and estimated cost due to the mobilization(s) based upon prior profitability of the business.

Various aspects of the invention may provide one or more of the following capabilities. A financially-sound insurance system for providing military reservists with supplemental income to compensate for active military duty may be provided. Reservists can guard against financial hardship brought on by calls to active military service. Insurance can be provided for military reservists without requiring outside funding, thus providing a self-sufficient insurance system.

These and other capabilities of the invention, along with the invention itself, will be more fully understood after a review of the following figures, detailed description, and claims.

### BRIEF DESCRIPTION OF THE FIGURES

FIG. 1 is a block diagram of an exemplary insurance policy according to the invention.

FIG. 2 is a block flow diagram of a process of issuing and implementing the insurance policy shown in FIG. 1.

FIG. 3 is a block flow diagram of a process of providing disbursements according the insurance policy shown in FIG. 1.

### DETAILED DESCRIPTION OF PREFERRED EMBODIMENTS

Embodiments of the invention provide insurance for military reservists to provide supplemental income due to active military duty. A reservist may obtain a Mobilization Income Protection Program (MIPP) insurance policy. The reservist makes payments according to the policy. The amounts of the payments are preferably related to the maximum amount of disbursements that the reservist could seek under the policy if called to active duty, and related to the reservist's civilian income. If the reservist is called to active duty, then the reservist can request compensatory, supplemental income be disbursed to the reservist according to the policy. If a build-up period has passed since the reservist began making payments to the policy, and an elimination period has passed since the reservist is called to active duty, then disbursements can be made to the reservist for a benefit period of time up to a maximum benefit level. The reservist may be able to receive compensatory income under the policy after the call to active duty ends. A third party, such as a company or individual, may be paid some or all of the compensatory income if the reservist has elected a “key man insurance” option under the policy. Also, if less than a threshold amount of claims are made against the policy and/or less than a threshold cumulative amount of compensatory income is paid under the policy, a portion of the payments made to the policy may be returned if the reservist elected a “return of premium” option in the policy. Other embodiments are within the scope of the invention.

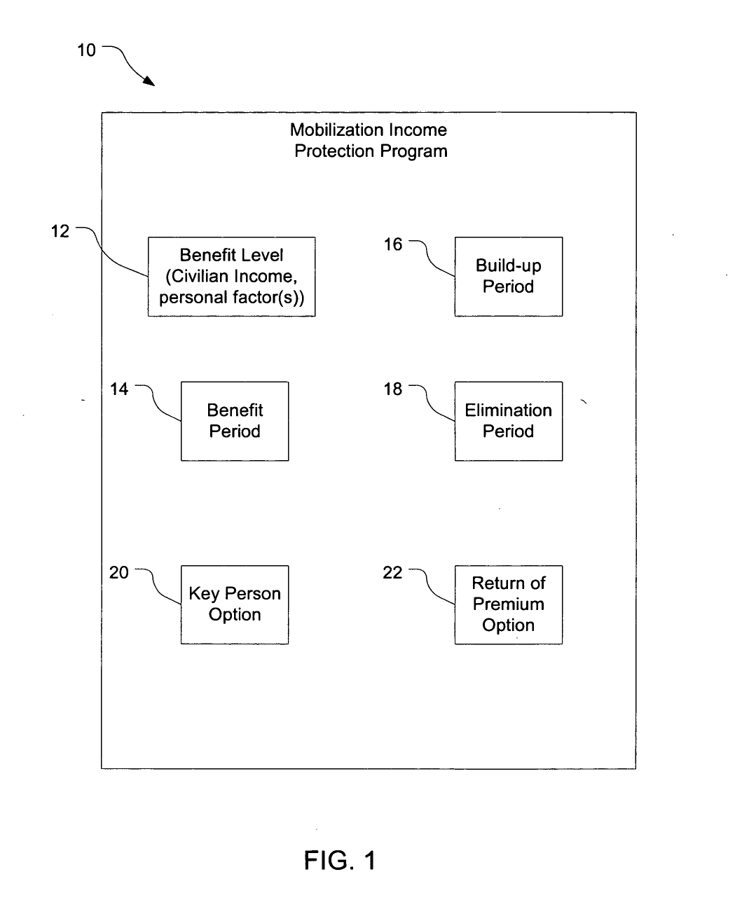

Referring to FIG. 1, a MIPP insurance policy 10 available from an insurer for military reservists includes provisions for benefit level 12, benefit period 14, build-up period 16, elimination period 18, key person 20, and return of premium 22. The insurance provided by the policy 10 treats active military duty like a disability to the reservist. Some of the provisions in the policy 10 are configurable, may vary from reservist to reservist, and may be elected or not elected. The policy 10 as a whole is designed such that reservists' incomes can be protected through an economically viable, preferably self-supporting program.

The benefit level provision 12 defines the amount of compensatory income to be received by a reservist that qualifies for disbursements. The amount of compensatory income to be received may be elected by the reservist. The benefit level is the periodic, e.g., monthly, amount to be received by the reservist. The benefit level amount may be limited based upon the reservist's civilian and military incomes, in particular the excess of civilian income over military income. If the reservist's military income exceeds the reservist's civilian income, then the policy 10 may not be available to the reservist. Thus, the reservist's civilian income is preferably verified, e.g., based on previous earnings, e.g., indicated by federal tax returns, W2s and/or 1099s. The benefit level may also be limited, e.g., with a maximum amount available per pay period or other unit of time. This maximum amount may be the same for different reservists, or may vary between reservists depending on one or more factors such as the reservist's civilian income, the reservist's likelihood of call-up to active duty (e.g., based on military pay grade, whether the reservist commands troops and how many, etc.), the likely length of any such call-up, etc. Other factors could include an individual's physical health, military job description, extent of military training and perceived shortages within the active duty forces of skilled personnel for an expected mission. The benefit level may be a constant level, or may vary between reservists, e.g., depending upon civilian pay, military pay, etc. The benefit level for a single reservist may be constant or may vary, e.g., as civilian and/or military pay changes, etc., as long as the benefit level does not exceed the designated maximum.

The benefit level provision 12 further defines the amount of premium payments to be made by the reservist. The payment amounts depend upon one or more occupational demographics of the reservist and/or one or more personal factors of the reservist. For example, preferably the amount owed by the reservist depends upon the amount of compensatory income to be paid, and the reservist's civilian income level. All other things being equal, reservists with higher civilian incomes will need to pay more for the same prospective benefit level. Further, the amount owed by a reservist may depend upon at least one of an age of the reservist, length of occupation of the reservist in the reservist's current civilian occupation, length of occupation of the reservist in the reservist's current military occupation, formal academic background of the reservist, marital status of the reservist, number of household dependents of the reservist, military pay grade of the reservist, number of years of military experience, number of years of civilian employment, level of military responsibility, whether and how many troops the reservist commands at the reservist's military occupation, and level of civilian-employment responsibility. Essentially, as the likelihood of call-up and/or the likely length of any call-up increases, so does the payment that the reservist will need to make.

The benefit period provision 14 defines the duration of disbursements from the insurer to the reservist. This duration may be an amount of time during which the reservist may receive disbursements under the policy 10. For example, the benefit period is preferably a short-term policy that will pay the reservist up to, e.g., one year, two years, etc. Alternatively, the benefit period may be defined in terms of total amount of compensatory disbursements provided. For example, if the benefit level is allowed to vary, then the benefit period may be a total cumulative disbursement amount that, if reached, will terminate the disbursements. Different cumulative amounts may be specified for a single military deployment and multiple deployments (e.g., different amounts up to a predetermined number of deployments, after which the cumulative amount does not vary). Typically, reservists are mobilized for tours of active duty of 12 months or less, although longer tours of duty are not unheard of.

As part of the benefit period provision 14, or possibly as a separate option, the policy 10 may specifically provide for the reservist to receive compensatory income after an active duty call-up ends. This post-duty benefit period can help the reservist that returns to civilian life to find the reservist's job gone, or whose job is lost soon after return to civilian life. The reservist may be left without a job, or with a job that has a lower income than the job the reservist had at the time of military call-up. The benefit period may thus include time for the reservist to find new employment or to otherwise get re-established in a professional capacity. As no military pay will be received upon release from active duty, the policy 10 may compensate for this loss combined with a reduction in civilian income compared to when the reservist was called to duty. Preferably, the time period for this post-duty benefit is one year. This may be included as part of the base benefit period such that the benefit period is, e.g., two years to allow disbursements to the reservist as long as the reservist is on active duty, and has returned to civilian duty but whose civilian income has declined since being called up. Payments made to the reservist after being relieved from active military duty may be in amounts that are lower than amounts paid to the reservist during active military duty.

The build-up period provision 16 defines the duration of payments to the insurer by the reservist before disbursements will be made by the insurer to the reservist. The build-up period is designed to help ensure that the MIPP is economically viable, especially if the reservist falls in a demographic class where claims are likely to be submitted before the policy has accumulated sufficient capital to be economically viable otherwise. This duration may be an amount of time before which the reservist may not receive disbursements under the policy 10. For example, the build-up period may be months or even years. Alternatively, the build-up period may be defined in terms of total amount of payments made. For example, some reservists may already be mobilized, or expected to be deployed, e.g., in the near future. A one-year period may be required for any reservist signing up for the policy 10, and this period may be longer for reservists that are currently mobilized or deployed, or expected to be deployed within a certain time, e.g., one year.

The elimination period provision 18 dictates a duration after an insured event, e.g., call-up to active military duty, that must pass before disbursements will be made to the reservist. This duration may be an amount of time before which the reservist may not receive disbursements under the policy 10. For example, the elimination period may be days, weeks, or months. Alternatively, the elimination period may be defined in terms of total amount of payments made after the insured event. The elimination period eliminates short-term deployments from triggering payments, as the reservist is not expected to be dramatically financially affected by short-term deployments, and helps to ensure the financial viability of the MIPP. Since reservists are often sent forth on short-term deployments, the elimination period 18 could be set, e.g., at 30 days, to exclude from disbursements annual training or other short time periods. Occupations that traditionally offer more than 30 days of scheduled vacation per annum, such as school teachers and professors, can be excluded from coverage eligibility at least during these times of scheduled vacation.

The key person provision 20 is designed to provide special assistance to businesses where a reservist is key to the operation of the business, e.g., a key member of management, or a sole proprietor. Key person insurance thus provides not only compensatory income for the reservist, but also provides fuids to the business to hire a qualified replacement during the reservist's absence (e.g., a retired person qualified to perform the reservist's job). This provision may result in substantial outlays of monies, as the disbursements may be nearly double the reservist's pay (i.e., the pay for the replacement employee plus the difference between the reservist's civilian income and the reservist's military pay). The key person provision 20 can help maintain stability in the reservist's business and avoid otherwise catastrophic effects on that business. The key person provision 20 may be provided as part of the policy 10 or as a separate policy.

As an alternative, or in addition, to the key person provision 20, the policy 10 (or a separate policy) may provide for compensation to a business due to one or more reservists' absences, even if the reservist(s) is(are) not considered of fundamental importance to the business. This insurance may be modified to assess the affect of the loss of the reservist on the business and to provide for compensation for this loss if the reservist is called to active duty. Costs can be incurred by employers due to lost productive time. Personnel absent due to mobilization may induce one or more of a variety of consequences affecting profitability of a business. For example, other employees may be forced to work extra, including overtime, recruiting of new employees may be undertaken (including Human Resources time and other employee time, including management, to interview candidates), etc. Replacement employees will likely be less productive initially than the employees that they replace. Thus, the provision 20 may provide for paying money to compensate for this lost productivity. The amount of payments made to secure this provision may be based on the number of reservists, likelihood of mobilization, etc. The amount paid may be a fixed amount (e.g., per reservist mobilized), partially fixed and partially variable, or all variable. Variable compensation may depend on, e.g., number of persons mobilized, length of expected mobilization(s), cost estimates based upon prior profitability, etc. The provision 20 may be applied as a Rider or an Option. This provision may be similar to Overhead Insurance or Business Income Coverage that is typically designed to protect businesses against loss of revenue to damage to property such as equipment or a building. This insurance may be obtained by the reservist, or possibly by the business itself.

The return of premium provision 22 provides for the return of a portion of the payments made by the reservist if the reservist has not received significant disbursements from the MIPP under the policy 10. For example, if no claims are ever made for disbursements, or if fewer than a threshold number of claims are made, or if less than a threshold amount of money is disbursed under the policy 10, then the reservist may be entitled to a return of some of the money paid into the MIPP. The amount returned to the reservist may depend on various factors such as an amount (e.g., percentage of payments, or absolute dollar amount) desired to be returned, the number of claims made, the amount of total distributions made under the policy 10, and/or the amount of payments made under the policy 10, etc. Opting for the return of premium provision 22 will increase the amount that the reservist will pay into the program. As with other provisions of the policy 10, the return of premium provision 22 may not be provided at all, and/or may not be elected by the reservist.

There may be various tax consequences associated with participation in the MIPP. Whether premiums paid are tax deductible by the reservist and whether the insurance benefits received are taxable depends on what category of money was used to make the payments. Pre-tax dollars can be used to purchase insurance products, e.g., taken directly from an insured person's paycheck before payroll taxes are assessed. Insurance policies, including disability insurance, purchased with pre-tax dollars often produce a taxable event if/when benefit money is received by the insured. If premiums on the policy 10 are paid with dollars that have already been taxed, then the benefit money disbursed will likely be tax-free.

Preferably, the payments under the policy 10 will be made using pre-tax dollars as the MIPP intends to ensure financial stability for military reserve component personnel that have been involuntarily mobilized. Using pre-tax dollars would lower the amount of payroll tax assessments. The disbursements made under the policy 10 would then be taxable income. The amount of taxation, however, would likely be no different than what the reservist had been paying due to the reservist's overall gross income being essentially the same, assuming the benefit level approximates the gap or difference between the reservist's civilian income rate and the reservist's active military duty income rate.

The MIPP may be reinsured, that is, the policies 10 that are issued to reservists may themselves be insured by the primary insurer through a secondary insurer. The primary insurer may take out an insurance policy with another, secondary insurer to guard against financial ruin of the primary insurer should a large number of claims be made under the policies 10 to the primary insurer producing an exceptional volume of disbursements. Indeed, the secondary insurer may also take out a reinsurance policy, known as retrocessions.

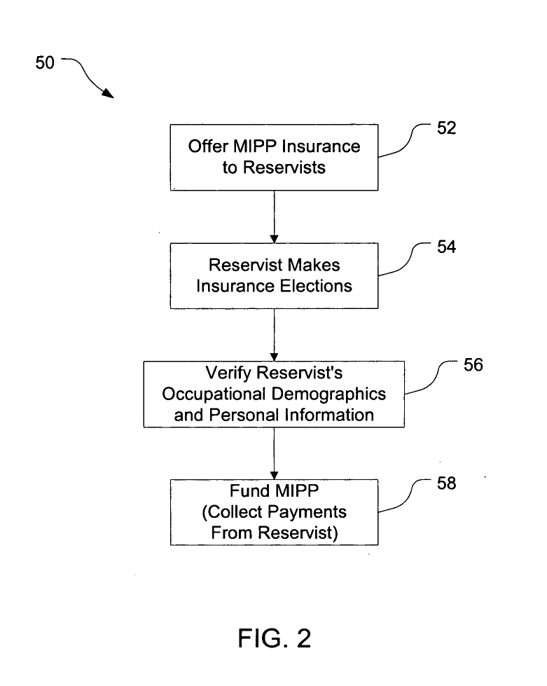

In operation, referring to FIG. 2, with further reference to FIG. 1, a process 50 for issuing and implementing the insurance policy 10 includes the stages shown. The process 50, however, is exemplary only and not limiting. The process 50 may be altered, e.g., by having stages added, removed, or rearranged.

At stage 52, the policy is offered to the reservist. The MIPP is made known to reservists through appropriate communications channels. The MIPP may be provided by a private insurance carrier, e.g., in cooperation with the military or other portion of the Government.

At stage 54, the reservist signs up for benefits under the policy 10. The reservist selects which options the reservist wants, e.g., the return premium provision 22. The reservist also selects appropriate values associated with the provisions of the policy 10, e.g., the benefit level, the frequency of distributions, the amount of premium reimbursement, a desired benefit period, etc. At this time, the reservist also provides occupational demographic information (e.g., civilian job, civilian income, etc.) and personal information (e.g., age, academic background, marital status, number of dependents, etc.).

At stage 56, the information provided by the reservist is verified. For example, the reservist's tax returns, W2s, 1099s, etc. may be analyzed, as well as other checks to confirm the veracity of the information provided by the reservist, particularly any information that will affect the amount paid by and/or to the reservist under the policy 10, especially the reservist's status as a key person/employee and the income needed to hire a suitable/qualified replacement in the reservist's absence.

At stage 58, the MIPP is funded. For example, premium payments are collected from the reservists in the MIPP. The payments are stored, and preferably invested, for use in providing disbursements of compensatory income to qualifying reservists. Funds may also, or alternatively, be gathered from other governments, in particular the militaries of other countries, by an insurance manager in a slush fund. The slush fund would be the repository for funds to be disbursed to qualifying reservists from any of the countries contributing to the slush fund.

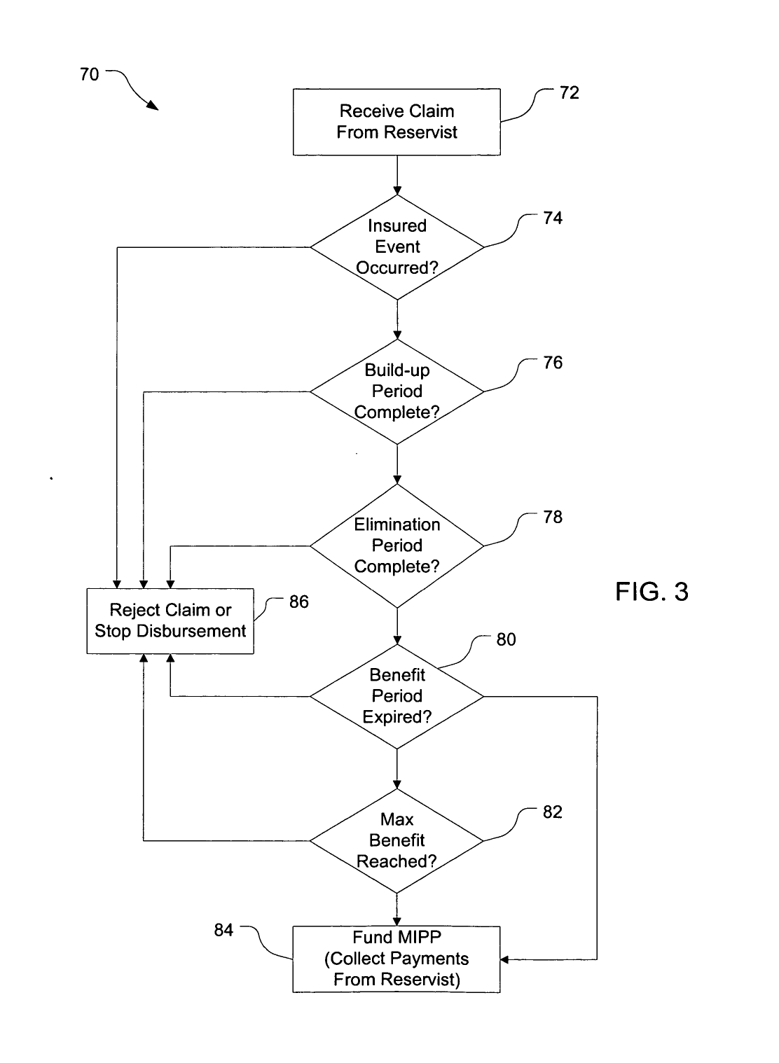

In operation, referring to FIG. 3, with further reference to FIGS. 1-2, a process 70 of providing disbursements according the insurance policy 10 includes the stages shown. The process 70, however, is exemplary only and not limiting. The process 70 may be altered, e.g., by having stages added, removed, or rearranged.

At stage 72, the reservist makes a claim against the policy 10. The reservist fills out the appropriate paperwork requesting that compensatory income disbursements be made, e.g., to the reservist, a person or other entity designated in the policy 10 by the reservist, or to a person or other entity designated in the claim. A claim may also be automatically initiated by the military when the reservist is called to or reports for active duty. The claim is evaluated to determine whether payments are warranted, and if so, in what amount.

At stage 74, an inquiry is made as to whether an insured event has occurred. Here, it is determined whether the reservist has been called to involuntary active duty, or if reporting for voluntary active duty, whether that qualifies under the policy 10 as an insured event. If an insured event has not occurred, then the process 70 proceeds to stage 86, described below. If an insured event has occurred, then the process 70 proceeds to stage 76.

At stage 76, an inquiry is made as to whether the build-up period is complete. Here, it is determined whether the reservist has been making payments for sufficient time, or possibly whether the reservist has made adequate total payments. If the build-up period is not complete, then the process 70 proceeds to stage 86, described below. If the build-up period is complete, then the process 70 proceeds to stage 78.

At stage 78, an inquiry is made as to whether the elimination period is complete. Here, it is determined whether sufficient time has passed since the occurrence of the insured event (or other criteria met). If the elimination period is not complete, then the process 70 proceeds to stage 86, described below. If the elimination period is complete, then the process 70 proceeds to stage 80.

At stage 80, an inquiry is made as to whether the benefit period is complete. Here, it is determined whether the reservist has been receiving disbursement for the allowed time. This benefit period may include time after the reservist is relieved from active military duty, e.g., if the reservist verifies that the active military duty resulted in a decrease (including elimination) of the reservist's civilian pay. If the benefit period is complete, then the process 70 proceeds to stage 86, described below. If the benefit period is not complete, then the process 70 proceeds to stage 82.

At stage 82, an inquiry is made as to whether the maximum amount of disbursements has been reached. Here, it is determined whether the reservist has been paid a predetermined maximum amount (e.g., for this particular deployment, or for multiple deployments). If the appropriate maximum benefit amount (e.g., for a single deployment or multiple deployments, the amounts for which possibly being different) has been reached, then the process 70 proceeds to stage 86, described below. If the maximum benefit amount has not been reached, then the process 70 proceeds to stage 84.

At stage 84, the insurer disburses compensatory money on behalf of the reservist. The compensatory income may be disbursed to the reservist, or to an entity designated by the reservist (e.g., a spouse). For Key Person insurance, Overhead Insurance, or Business Income Coverage, disbursements are preferably made to the appropriate business or other designee of the reservist. The process 70 returns to stage 80 to determine if further disbursements are warranted.

At stage 86, the reservist's claim is rejected, or further payments are terminated. If the reservist's claim in unjustified, e.g., because the build-up period or elimination period is incomplete, or an insured event has yet to occur (or recur), then the reservist's claim is rejected and the reservist appropriately informed. If the reservist's claim has been granted/approved, but disbursements are no longer warranted, e.g., because the benefit period has expired, or the maximum allowable amount of payments to or on behalf of the reservist has been made, then the disbursements are terminated and the appropriate party(ies), e.g., the reservist, the reservist's business, and/or the reservist's designee(s), are appropriately informed of the cessation of payments.

Other embodiments are within the scope and spirit of the appended claims. For example, several governments could pool resources to produce a slush fund for insuring each other's military reservists in case of military call-ups. The money put into the slush fund may or may not be obtained, or may be partially obtained, from the reservists themselves through payments into insurance policies. Such a slush fund may be managed by an insurance provider, but funded by various governments, e.g., a bloc of allies. Further, some amount of money may be paid before an build-up period has expired. For example, a portion of the benefit amount may be paid before the build-up period is reached. The portion paid may vary, increasing as the end of the build-up period approaches. The amount paid may not reach the full benefit amount until after the build-up period has been reached to help compensate for money being paid in advance of the build-up period being reached.

1. A method of insuring military reserve component personnel for reduction of income due to active military duty, the method comprising:
collecting payments on behalf of a reservist, amounts of the payments being based upon civilian income of the reservist and desired compensatory income during times of active military duty; and
providing the desired compensatory income for the reservist during at least a portion of a first time period of active military duty of the reservist in response to receiving a request for compensatory income on behalf of the reservist.

2. The method of claim 1 wherein the payment amounts are further based on at least one personal factor associated with the reservist.

3. The method of claim 2 wherein the at least one personal factor is at least one of an age of the reservist, length of occupation of the reservist in the reservist's current civilian occupation, length of occupation of the reservist in the reservist's current military occupation, formal academic background of the reservist, marital status of the reservist, number of household dependents of the reservist, military pay grade of the reservist, number of years of military experience, number of years of civilian employment, level of military responsibility, whether and how many troops the reservist commands at the reservist's military occupation, and level of civilian-employment responsibility.

4. The method of claim 1 wherein providing the compensatory income is inhibited until at least one of a first threshold cumulative total of payments is collected, a second threshold of number of payments is collected, and a third threshold of a designated time period during which payments have been collected elapses.

5. The method of claim 1 wherein at least a portion of the compensatory income is provided during a second time period after the first time period, wherein the reservist is off active military duty during the second time period.

6. The method of claim 1 wherein the compensatory income includes a desired replacement income for paying a person to replace the reservist at the reservist's civilian occupation while the reservist is on active military duty, and wherein the payment amounts further depend upon the desired replacement income.

7. An insurance policy for military reserve component personnel for compensating for reduction of income due to active military duty, the insurance policy comprising provisions for:
collecting payments, amounts of the payments being based upon civilian income of a reservist and desired compensatory income for the reservist during at least times of active military duty of the reservist;
receiving a request for compensatory income; and
providing the desired compensatory income during at least a portion of a time period of active military duty of the reservist.

8. The policy of claim 7 wherein the payment amounts are further based on at least one personal factor associated with the reservist.

9. The policy of claim 8 wherein the at least one personal factor is at least one of an age of the reservist, length of occupation of the reservist in the reservist's current civilian occupation, length of occupation of the reservist in the reservist's current military occupation, formal academic background of the reservist, marital status of the reservist, number of household dependents of the reservist, military pay grade of the reservist, number of years of military experience, number of years of civilian employment, level of military responsibility, and level of civilian-employment responsibility.

10. The policy of claim 7 further comprising a provision to inhibit the compensatory income from being provided until at least one of a first threshold cumulative total of payments is collected, a second threshold of number of payments is collected, and a third threshold of a designated time period during which payments have been collected elapses.

11. The policy of claim 10 wherein the provision to inhibit the compensatory income from being paid allows a portion, less than a full amount, of the compensatory income to be paid before at least one of the first threshold cumulative total of payments is collected, the second threshold of number of payments is collected, and the third threshold of the designated time period during which payments have been collected elapses.

12. The policy of claim 7 further comprising a return of premium provision for returning a portion of the payments collected if at least one return condition is satisfied, the payment amounts further depending upon election of a return of premium option.

13. The policy of claim 12 wherein the return condition is at least one of that no requests for compensatory income are received, and that compensatory income provided under the plan is below a threshold level relative to a sum of payments collected under the insurance plan.

14. An insurance policy for military reserve component personnel for compensating for reduction of income due to active military duty, the insurance policy comprising provisions for:
collecting payments, amounts of the payments being based upon desired compensatory income for a reservist during at least times of active military duty of the reservist;
providing the desired compensatory income during at least a portion of a first time period of active military duty of the reservist; and
providing at least a portion of the compensatory income during a second time period after the first time period, wherein the reservist is off active military duty during the second time period.

15. The policy of claim 14 wherein the amounts of the payments are also based upon civilian income of the reservist.

16. An insurance policy for military reserve component personnel for compensating for reduction of income due to active military duty, the insurance policy comprising provisions for:
collecting payments, amounts of the payments being based upon desired compensatory income for a reservist during at least times of active military duty of the reservist; and
providing the desired compensatory income during at least a portion of a time period of active military duty of the reservist;
wherein the compensatory income includes a desired replacement income for paying a person to replace the reservist while the reservist is on active military duty; and
wherein the payment amounts depend upon the desired replacement income.

17. The policy of claim 16 wherein the amounts of the payments are also based upon civilian income of the reservist.

18. An insurance policy for military reserve component personnel for compensating for business impact of the personnel's absence due to active military duty, the insurance policy comprising provisions for:
collecting payments, amounts of the payments being based upon desired compensatory income that is based on expected financial impact on a business of a reservist's absence during at least times of active military duty of the reservist; and
providing the desired compensatory income during at least a portion of a time period of active military duty of the reservist.

19. The policy of claim 18 wherein the amounts of payments are based on at least one of number of reservists in the business and likelihood of the reservist(s) being mobilized.

20. The policy of claim 18 wherein the desired compensation is at least partially dependent on at least one of a number of persons mobilized, length of expected mobilization(s), and estimated cost due to the mobilization(s) based upon prior profitability of the business.
